(19) United States
(12) Patent Application Publication
(10) Pub. No.: US 2004/0163559 A1
(43) Pub. Date: Aug. 26, 2004

(54) Label printer

(76) Inventor: Marfred Korthauer, Mulheim/Ruhr (DE)

Correspondence Address: PROSKAUER ROSE LLP, PATENT DEPARTMENT, 1585 BROADWAY, NEW YORK, NY, 10036-8299, US

(21) Appl. No.: 10/477,003

(22) PCT Filed: Apr. 19, 2002
(86) PCT No.: PCT/EP02/04328

(30) Foreign Application Priority Data
May 17, 2001 (DE) 101 24 322.7

(51) Int. Cl. B41F 1/08

(52) U.S. Cl. 101/288

(57) ABSTRACT

The invention relates to a label printer for printing labels that are removably arranged on a carrier band (1), in particular merchandise labels, comprising at least one printing device (4) with a printing head (2) for printing the labels, and at least one label guide (8) with at least one printing pad (6). In order to simplify the operation of the label printer and to ensure a fast and user-friendly insertion of the carrier band, the invention proposes that the label guide (8) is supported such that it can be pivoted about an axis (10), wherein the ability to pivot the label guide (8) allows adjusting the label guide (8) into at least one loading position and into at least one operating position, that the printing pad (6) is spatially apart from the printing head (2) in the loading position of the label guide (8), wherein the carrier band (1) can be inserted into the label guide (8) in the loading position, and that the printing pad (6) is spatially arranged on the printing head (2) in the operating position of the label guide (8), wherein the labels of the carrier band (1) can be printed with the aid of the printing head (2) in the operating position.

The invention relates to a label printer for printing labels that are removably arranged on a carrier band, in particular merchandise labels, comprising at least one printing device with a printing head for printing the labels and at least one label guide with at least one printing pad. The invention also relates to a method for inserting a carrier band carrying into a label printer, wherein the carrier band is guided by a label guide that contains a printing pad.

Known label printers for printing labels that are removably arranged on a carrier band usually contain a complicated mechanism for transporting the carrier band to the printing head. This mechanism ensures that the carrier band is transported to the printing head under sufficient pressure and with the speed defined by a control unit. After the label arranged on the carrier band has been printed, it is conventionally removed from the carrier band. The empty carrier band is additionally transported by an advancing unit that usually comprises two deflection rolls, wherein the two deflection rolls are realized in such a way that the looping angle of the carrier band around the rolls is enlarged. This ensures the required frictional connection between the carrier band and the advancing unit. The carrier band is further transported in the direction of a wind-up reel or another receptacle device, for example, a Liporello magazine or a shredder. The carrier band needs to be exchanged once all labels on the carrier band have been printed. In conventional printers, the printing head is lifted off the carrier band and the carrier band is removed from the mechanism. A new carrier band can then be inserted into the complicated mechanism. Since the carrier band is conventionally guided over a series of rolls, the insertion of the carrier band into the mechanism is relatively complicated. It is absolutely imperative to properly insert the carrier band into the mechanism because a flawless printing of the labels arranged on the carrier band would otherwise be impossible. After the carrier band is guided from the unwinding reel to the wind-up reel via the mechanism, the printing head is moved toward the carrier band and the label printing process can resume.

One problem in the described devices can be seen in the fact that the exchange of the carrier band is relatively complicated. Untrained personnel is frequently unable to properly exchange the carrier band. An exchange of the carrier band is also very time-consuming. In addition, the carrier band is damaged if it is not properly inserted. This leads to misprints that increase the costs.

Consequently, the invention is based on the objective of ensuring a simpler insertion of the carrier band into the label printer. The invention also aims to simplify the operation of the label printer and to ensure a fast and user-friendly insertion of the carrier band.

According to the invention, the above-described objective that is derived from the prior art is attained in that the label guide is supported such that it can be pivoted about an axis, wherein pivoting the label guide allows adjusting the label guide into at least one loading position and into at least one operating position, that the printing pad is spatially apart from the printing head in the loading position of the label guide, wherein the carrier band can be inserted into the label guide in the loading position, and that the printing pad is spatially arranged on the printing head in the operating position of the label guide, wherein the labels of the carrier band can be printed with the aid of the printing head in the operating position.

According to the invention, the ability to pivot the label guide about an axis significantly simplifies the insertion of the carrier band into the label printer. In this case, the label guide is designed in such a way that it can be pivoted about an axis and is able to assume at least one loading position and one operating position.

In the loading position, the spatial distance between the printing pad and the printing head is very large such that the carrier band can be easily inserted. In the operating position, the printing pad is located spatially directly at the printing head such that the labels can be printed. The ability to pivot the label guide makes it possible to eliminate the complicated feed mechanism known from the prior art. In the operating position, the carrier band is guided through the printing device underneath the printing head. The printing head prints the labels arranged on the carrier band. The pivoting of the label guide generates on the one hand a contact pressure between the printing head and the printing pad, and on the other hand the carrier band is sufficiently tensioned such that a uniform and clean printing result is obtained.

According to one advantageous embodiment of the label printer, the label guide comprises a stripping head for removing the label from the carrier strip. The stripping head may consist of an edge of the label guide which has a small radius and/or of a small roll. After the label has been printed, the carrier band can be guided over the stripping head in order to remove the label from the carrier band. The empty carrier band is fed, for example, to a wind-up reel by the label guide.

According to another advantageous embodiment of the label printer with the features of claim 1, which demonstrates independent inventive merit, the stripping head is spatially arranged on the printing pad. The spatial arrangement of the stripping head on the printing pad allows providing the labels with variable data during the printing process. Such variable data may, for example, consist of the data of a scale that records the weight of the merchandise to be labeled. In addition, the size, or the type of the merchandise to be labeled may be a decisive factor as to the manner, in which the label needs to be printed.

According to another advantageous embodiment of the label printer, the label guide comprises an advancing device. The advancing device preferably consists of a drive and a roll, over which the label is guided. The roll may, for example, have a rough surface in order to ensure a better transport of the carrier band. The transport band is transported along the label guide with the aid of the advancing device. The advancing device is responsible for transporting the carrier band past the printing head with a uniform speed and under a sufficient tension. The advancing device also assists in transporting the empty carrier band in the direction of the wind-up reel.

In another embodiment of the label printer with the features of claim 1 which demonstrates independent inventive merit, the advancing device is spatially apart from a counterpressure roll in the loading position and spatially arranged on the counterpressure roll in the operating position. When inserting the transport band into the label guide, it is advantageous to considerably space apart the advancing device and the counterpressure roll. This ensures inserting the band easily. It is not necessary to carry out a complicated insertion of the carrier band between the advancing device and the counterpressure roll. According to this embodiment, the counterpressure roll only adjoins the advancing device in the operating position. It is advantageous to arrange the counterpressure roll on the advancing roll of the advancing device. An good adjustment of the carrier band on the advancing device is achieved due to the fact that the width of the counterpressure roll is smaller than the width of the roll of the advancing device. This prevents the carrier band from shifting during its transport along the advancing device. The counterpressure roll ensures that the frictional connection between the advancing device and the carrier band suffices for transporting the carrier band along the label guide. The counterpressure roll preferably carries an outer casing of a compressible material. This additionally improves the frictional connection between the advancing device and the transport band.

In order to prevent frictional losses during the transport of the carrier band along the label guide, the label guide according to another embodiment of the invention comprises at least one deflection roll reducing frictional losses. The carrier band is guided along the at least one deflection roll. The frictional losses are reduced by the at least one deflection roll because the rolling resistance is lower than the frictional resistance. Consequently, the advance of the carrier band can be realized with a lower motor power such that the dimensions of the advancing motor can be reduced.

The printer preferably is a thermal printer, in which a thermal strip locally heats and thusly prints the thermosensitive labels. However, the printing head may also form part of a thermal transfer printer, an ink-jet printer, a matrix printer or a laser printer.

It is also proposed that the printing device is arranged spatially fixed. In this respect, it should be noted that the printing head itself does not have to remain completely stationary, but may be supported with at least one degree of freedom, for example in a springable fashion. The stationary arrangement of the printing device always ensures an adequate adjustment of the printing head relative to the label guide. In addition, the stationary arrangement of the printing device also lowers the susceptibility to defects of the printing head. Since the printing device is arranged stationarily, it is merely required to pivot the label guide in the direction of the printing head in order to guide the labels to the printing head.

A particularly homogeneous print is achieved if the printing pad has a compressible pad that makes it possible to realize a uniform contact pressure between the printing head and the printing pad. The compressible pad may consist of a fleece, a felt or an elastomer with sliding characteristics, as well as of a composite material consisting of plastic with fleece, felt or an elastomer with metal or metal alloys. It would also be conceivable to utilize a roll with a compressible surface instead of a solid compressible pad. The compressible pad merely needs to ensure that the unevenness between the printing pad and the printing head is essentially compensated along the entire printing head. The uniform contact pressure ensures that a homogeneous print is achieved along the entire label.

Since adhesive residues and paper remnants adhere to the rolls and shafts during the printing process, it is necessary to maintain a regular cleaning schedule. In order to simplify the cleaning of the rolls and shafts, it is proposed that the counterpressure roll, a shaft of the advancing device and/or the deflection roll can be removed from the label printer at least perpendicular to the axis of rotation. The ability to remove the rolls and shaft perpendicular to the axis of rotation significantly simplifies the removal process because it is no longer required to remove the rolls and shafts along the axis of rotation as it is known from the prior art. In this case, it was always required to disengage a locking mechanism of the shafts and rolls at the axis of rotation.

In order to ensure that the carrier band containing the labels is consistently transported to the printing head, it is proposed that the printing device contains a deflection device that guides the carrier band to the printing head. This deflection device may consist of a roll or of an edge with a radius.

In order to improve the print and to ensure a uniform contact pressure between the printing pad and the printing head, it is proposed that the printing device contains means for generating a contact pressure between the printing head and the printing pad in the operating position. This means may, for example, consist of a flexible sheet metal arranged above the printing head or of a spring.

Another aspect of the invention is a method for inserting a carrier band carrying labels into a label printer, wherein the carrier band is guided over a label guide that contains a printing pad. This method is characterized in that the label guide is pivoted into a loading position for inserting the carrier band into the label printer, and in that the label guide with the transport band inserted therein is pivoted into an operating position, in which the printing is spatially arranged pad on the printing head, in order to print the labels. A label printer of the previously described type is preferably used for carrying out this method. The label guide is pivoted into the loading position about an axis. In the loading position, the distance between the printing pad and the printing head is relatively large such that the transport band no longer has to be threaded between the printing pad and the printing head. After the carrier band has been inserted into the label guide, the label guide is pivoted in the direction of the printing head about the pivoting axis. This pivoting of the label guide causes the printing pad to adjoin the printing head such that the labels are directly guided along the printer, for example a thermal strip. The carrier band containing the labels preferably arrives from an unwinding reel or a label magazine. The empty carrier band is preferably transported to a wind-up reel, a shredder or a magazine.

A particularly advantageous guidance of the transport band along the label guide is ensured by guiding the carrier band along the label guide with the aid of an advancing device, and by producing a frictional connection between the advancing device and the carrier band by a counterpressure roll in the operating position.

The advancing device is preferably arranged on the label guide. This means that the advancing device is pivoted together with the label guide. In the loading position, the advancing device is spatially removed from the counterpressure roll such that the transport band can be easily inserted into the label guide. When the label guide is pivoted into the operating position, the advancing device is pivoted in the direction of the counterpressure roll. This causes a contact pressure to be generated between the counterpressure roll and the advancing device in the operating position. This contact pressure ensures the transport of the carrier band once the advancing device is activated.

One preferred embodiment of the invention is described in greater detail below with reference to the figures. The figures show:

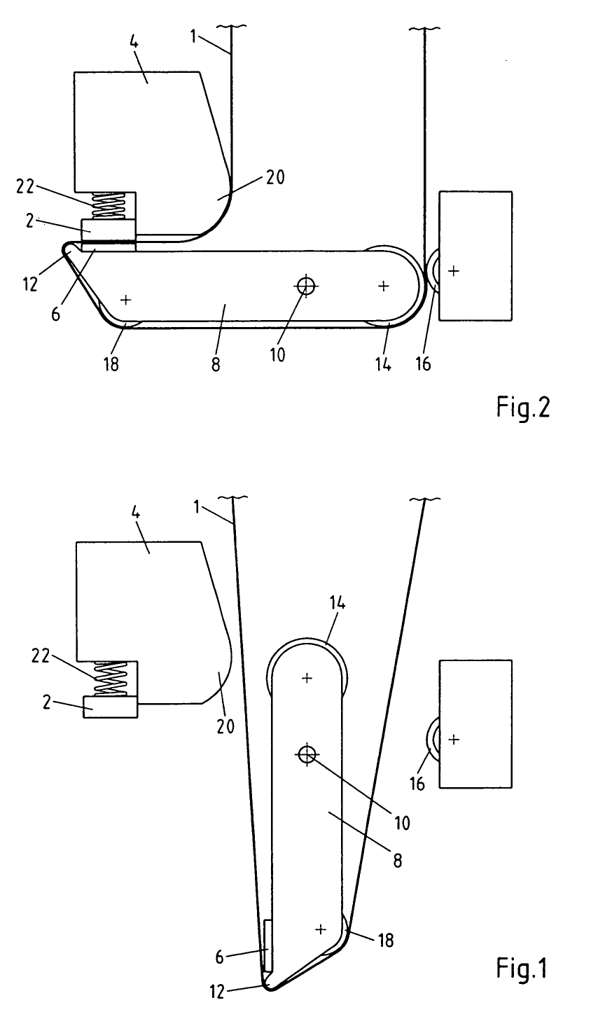

FIG. 1 a label printer according to the invention in the loading position, and

FIG. 2 a label printer according to the invention in the operating position.

FIG. 1 depicts a label printer according to the invention. This label printer contains a label guide 8. A printing pad 6, a stripping head 12, a deflection roll 18 and an advancing device 14 are arranged on the label guide 8. The label guide 8 can be pivoted about an axis 10. FIG. 1 also shows a printing device 4 that comprises a printing head 2 and a pressing spring 22. The pressing spring 22 may also be realized in the form of a metal sheet. A deflection device 20 is also arranged on the printing device 4. In addition, the label printer shown also contains a counterpressure roll 16.

In the loading position shown, the label guide 8 is pivoted about the axis 10 in such a way that the printing pad 6 and the stripping head 12 are spaced apart from the printing head 2 by a large distance. The distance between the advancing device 14 and the counterpressure roll 16 is also relatively large. The carrier band 1 arriving from the unwinding reel is guided along the label guide 8 in this position. The transport band is guided to the advancing device 14 via the printing pad 6, the stripping head 12 and the deflection roll 18. The band is then guided to a wind-up reel. It would also be conceivable to transport the empty carrier strip to a shredder instead of a wind-up reel. In addition, a Liporello magazine accommodating Liporello labels that are arranged on a folded carrier band may be provided instead of the wind-up reel. The large distance between the printing pad 6 and the printing head 2 and between the advancing device 14 and the counterpressure roll 16 significantly simplifies the insertion of the carrier band 1 into the label guide 8. After the carrier band 1 has been inserted into the label guide 8, the label guide 8 is pivoted into the operating position shown in FIG. 2 about the axis 10.

FIG. 2 shows the operating position of the label printer according to the invention. In this operating position, the printing head 2 is situated directly above the printing pad 6. The pressing spring 22 generates a contact pressure between the printing head 2 and the printing pad 6. The carrier band containing the labels is guided between the printing head 2 and the printing pad 6. During the operation of the label printer, the carrier band 1 is guided over the deflection device 20. The deflection device 20 tensions the carrier band 1 in the direction of the stripping head 12. The transport band is guided toward the printing pad 6 from the deflection device 20. The printing pad 6 preferably consists of a compressible material. Such a compressible material provides the advantage that the unevenness between the printing pad 6 and the printing head 2 is uniformly compensated. The label is printed at the printed head 2 with the aid of a thermal strip. The printing process takes place during the transport of the carrier band 1. It is possible to print the labels with variable data which, for example, are generated by a scale during the printing process. The printed labels are then removed from the carrier band 1 at the stripping head 12 and applied to the respective merchandise by a (not-shown) labeling device. The empty carrier band is guided to the advancing device 14 via the deflection roll 18. In the operating position shown, the advancing device 14 directly adjoins the counterpressure roll 16. The carrier band 1 is transported between the advancing device 14 and the counterpressure roll 16. The contact pressure between the advancing device 14 and the counterpressure roll 16 produces a frictional connection between the advancing device 14 and the carrier band 16. The carrier band is transported along the label guide 8 by the advancing device 14. The empty carrier band is transported to a wind-up reel, a shredder or a Liporello magazine.

FIGS. 1 and 2 show that the carrier band can be very easily inserted into the label guide 8 in the loading position according to FIG. 1. It is merely required to place the carrier band over the stripping head 2. Once the label guide 8 is pivoted into the operating position shown in FIG. 2, the tension of the carrier band suffices for achieving a clean print image, wherein the transport of the carrier band from the unwinding reel to the wind-up reel is simultaneously ensured. The shafts of the deflection roll 18 and the counterpressure roll 16 can be removed perpendicular to their axis of rotation in order to simplify the cleaning of these rolls. The pivoting movement of the label guide 8 may be initiated manually or with the aid of a motor, as well as in a user-defined or event-controlled fashion. For example, the label guide 8 is automatically pivoted into the loading position shown in FIG. 2 when the end of the carrier band is reached.

The label printer shown is very easy to operate and consequently allows the flawless, fast and cost-efficient printing of labels.

1. A label printer for printing labels that are removably arranged on a carrier band (1), in particular merchandise labels, comprising
at least one printing device (4) with a printing head (2) for printing the labels, and
at least one label guide (8) which at least one printing pad (6),
characterized in
that the label guide (8) is supported such that it can be pivoted about an axis (10), wherein pivoting the label guide (8) allows adjusting the label guide (8) into at least one loading position and into at least one operating position,
that the printing pad (6) is spatially apart from the printing head (2) in the loading position of the label guide (8), wherein the carrier band (1) can be inserted into the label guide (8) in the loading position, and
that the printing pad (6) is spatially arranged on the printing head (2) in the operating position of the label guide (8), wherein the labels of the carrier band (1) can be printed with the aid of the printing head (2) in the operating position.

2. The label printer of claim 1, characterized in that the label guide (8) comprises a stripping head (12) for removing the label from the carrier strip (1).

3. The label printer of claim 2, characterized in that the stripping head (12) is spatially arranged on the printing pad (6).

4. The label printer of one of claims 1 to 3, characterized in that the at least one label guide (8) comprises an advancing device (14).

5. The label printer of one of claims 1 to 4, characterized in that the advancing device (14) is spatially apart from a counterpressure roll (16) in the loading position, and in that the advancing device (14) is spatially arranged on the counterpressure roll (16) in the operating position.

6. The label printer of one of claims 1 to 5, characterized in that the label guide (8) comprises a deflection roll (18) that reduces the frictional losses during the transport of the carrier band (1) along the label guide (8).

7. The label printer of one of claims 1 to 6, characterized in that the printing head (2) is a thermal printer, a matrix printer, a laser printer and/or an inkjet printer.

8. The label printer of one of claims 1 to 7, characterized in that the printing device (4) is arranged spatially fixed.

9. The label printer of one of claims 1 to 8, characterized in that the printing pad (6) comprises a compressible pad allowing to achieve a uniform contact pressure between the printing head (2) and the printing pad (6).

10. The label printer of one of the preceding claims, characterized in that the counterpressure roll (16), a shaft of the advancing device (14) and/or the deflection roll (18) can be removed from the label printer at least perpendicular to their axis of rotation.

11. The label printer of one of claims 1 to 10, characterized in that the printing device (4) contains a deflection device (20) that guides the carrier band to the printing head (2).

12. The label printer of one of the preceding claims, characterized in that the printing device (4) contains means (22) for generating a contact pressure between the printing head (2) and the printing pad (6).

13. A method for inserting a carrier band carrying labels into a label printer, in particular a label printer according to one of claims 1 to 12,
wherein the carrier band is transported from an unwinding reel to a wind-up reel via a label guide that contains a printing pad,
characterized in
that the label guide is pivoted into a loading position for inserting the carrier band into the label printer, and
that the label guide with the transport band inserted therein is pivoted into an operating position, in which the printing pad is spatially arranged on the printing head, in order to print the labels.

14. The method of claim 13, characterized in that the carrier band is transported along the label guide with the aid of an advancing device in the operating position, and in that a counterpressure roll produces a frictional connection between the advancing device and the carrier band in the operating position.
